(19) United States
(12) Patent Application Publication
(10) Pub. No.: US 2004/0111320 A1
(43) Pub. Date: Jun. 10, 2004

(54) Electronic shopping system

(76) Inventors: Jorg Schlieffers, Setauket, NY (US); Curt Croley, Stony Brook, NY (US); Jaeho Choi, Douglaston, NY (US); Alistair Hamilton, Stony Brook, NY (US); Eric M. Johnson, Stony Brook, NY (US); Thomas Wulff, North Patchogue, NY (US); Robert A. Spano, Smithtown, NY (US); Jerome Swartz, Old Field, NY (US); Carl J. Meshenberg, Long Beach, NY (US); David T. Lundquist, Stony Brook, NY (US); Jovan Milosavljevic, Staten Island, NY (US); Gene Niles, Islip Terrace, NY (US)

Correspondence Address: Himanshu S. Amin, Amin & Turocy, LLP, National City Center, 24th Floor, 1900 E. 9th Street, Cleveland, OH, 44114, US

(21) Appl. No.: 10/313,479

(22) Filed: Dec. 5, 2002

(51) Int. Cl. G06F 17/60

(52) U.S. Cl. 705/16

(57) ABSTRACT

Systems and methods for an electronic shopping system are provided. The electronic shopping system includes a shopping cart tablet and a mobile terminal that can be hand-held and/or coupled to any suitable product carrying device. The shopping cart tablet includes a display to display information relating to ordinary operation of the tablet and/or a mobile terminal. The shopping cart tablet also includes a charge cradle for charging the mobile terminal. The mobile terminal includes a window in which a bar code reader is able to read a bar code label and a display for displaying product information. A shopping cart handle is also included in the electronic shopping system for supporting the shopping cart tablet and mobile terminal. A storage rack that is operable to store and/or charge shopping cart tablets and/or mobile terminals is also included in the electronic shopping system.

### TECHNICAL FIELD

The present invention generally relates to an electronic shopping system. In particular, the present invention relates to systems and methods for a shopping cart tablet and mobile terminal.

### BACKGROUND OF THE INVENTION

Retail establishments are trying to become more efficient by applying different and innovative operating methods that help to increase their business's financial condition. One of the constantly pursued goals is the reduction of a customer's waiting time in a checkout line. Being able to speed up the flow of customers through a checkout station, or to reduce cost of a checkout transaction, is important to the success of a retail business. An evolution of the store checkout process has caused replacement of manual price keying of each item being purchased, for the process of scanning the item. Today, the bar code readers are commonly used in commercial and retail environments.

In a retail checkout transaction the consumer has to present all the items he/she wants to purchase to the cashier at a checkout register. The cashier scans each item. In addition, there may be an identification check if the customer is purchasing a restricted item, such as, but not limited to, alcohol or tobacco. The transaction is completed once all the items have been scanned, all the coupons have been accepted, the total costs have been calculated, and the customer has paid for the items. Although scanning the items at a checkout register takes less time than manually entering each item description into the computer, the sequential presentation to a cashier of each individual purchase can take a long time and create long lines of customers waiting to pay for their purchases. This can cause bottlenecks at the checkout stations, reduce throughput, make customers unhappy, and affect the financial condition of a retail establishment. Self-service checkout, or “self-checkout”, is a new way of conducting a checkout transaction and is a rapidly growing application in the retail environment. In a self-checkout system, each customer, rather than the cashier, scans the bar codes on the items being purchased. Presently there exist two types of self-checkout systems.

In the first type of self-checkout system, scanning takes place at a checkout station. After selecting the shopping items, a customer brings all the items to a checkout station. A checkout station comprises a scanner for reading product bar codes and coupons, a weighing scale for verifying purchased item price, and a checkout terminal for generating the final bill and accepting payment. At the checkout station, the customer scans the bar codes on the selected products, instead of having a cashier scan the items. After the purchases have been scanned and verified, the customer also scans any coupons he/she might have. The customer requests the final bill by selecting an appropriate button on the checkout terminal. In response to the customer's request, the total purchase price is displayed on the terminal screen and the bill is printed out. The customer tenders payment to the checkout terminal. The terminal can accept payments by any standard payment methods. Once the bill has been paid and the receipt has been issued, the self-checkout transaction is finished and the customer can leave the store.

However, although the self-checkout system described above reduces labor costs by not having the cashier scan each item at the checkout register, it does not reduce customer's checkout time. In fact, the system usually increases the time to checkout, because the consumers are not as experienced at scanning the products as the cashiers. Also, because product scanning does not take place until the customer completes his shopping item selection, the system does not provide the customer with the real-time item price information or the real-time total purchase price information. This lack of cost information during item selection affects consumer's shopping efficiency. Consumers may either underspend and not purchase all the needed items, or overspend and have to return some of the purchased products.

The second type of self-checkout system consists of a rack with portable scanning terminals. Price information for each item in the store is downloaded from the store's computer into the terminal's memory during a time when the system usage is low or the system is non-operational. Each customer receives one scanning terminal upon placing their ID or shopper loyalty card into a card reader (e.g., magnetic stripe reader or bar code reader) in the rack at a log-in station. While shopping, the customer uses the terminal to scan bar codes associated with his purchases. The terminal generally has two scan trigger keys: the plus trigger key and the minus trigger key. Each trigger activates the scanning module located inside the terminal. When the consumer wishes to add a product to the group of items he wants to purchase, he uses the add trigger key to scan the product bar code. This process adds the item to the consumer's purchased item list inside the terminal's memory. In case the customer decides to return one of the items previously added to the purchased item list, he scans the item bar code using the minus trigger key. This process deletes the product from the customer's purchase item list inside the terminal's memory. In each case the information regarding the scanned item is displayed on the terminal screen. This information may include the price of the returned item as well as the quantity of the item on the customer's buy list. The terminal also has a total key, which is used to display customer's total transaction costs based upon the prices stored in the terminal's memory. When the item selection has been completed, the customer places the scanning terminal back into the rack. The customer's shopping information, which has been stored in the scanning terminal's memory, is downloaded through the terminal rack to the store computer, where the customer's transaction file is created. A ticket having a bar code printed thereon, wherein the bar code is encoded with the address of the customer's transaction file inside the store computer, gets issued to the customer. The customer takes the ticket and proceeds to a checkout register. When the cashier scans the bar coded ticket, the transaction file is retrieved from the store computer. The store computer also determines the security verification measures that the customer will have to undergo at a checkout station. Those measures are determined based upon random probability function conditioned by the customer's scanning accuracy during the past self-checkout transactions and the content of the present transaction. In certain cases all of the customer's purchases may have to be re-scanned. After completion of the required security checks and acceptance of any coupons the customer might have, the final bill is calculated. The customer settles the bill by any standard payment method and leaves the store.

However, the price information displayed after scanning each item may not be synchronized to the point of sale system database, because the product price might have changed from the time when it was downloaded into the terminal to the time when the product bar code was scanned.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides systems and methods for an electronic shopping system. The electronic shopping system includes a shopping cart tablet and a mobile terminal that can be hand-held and/or coupled to a shopping cart or any other suitable product carrying device, such as a hand-held shopping basket. The tablet and/or mobile terminal can include a speaker and a graphic interface which manufacturers can use to advertise their products as well as provide information about its products to a customer. Retailers may use the tablet and/or mobile terminal to provide the customer with recipes, store advertisements, nutritional information, etc. Icons can be displayed by the graphical interface to promote the various products. The tablet and/or mobile terminal can also be employed to provide an easy link for the customer to the manufacturer's web site and/or the retailer's website for product information.

Thus, in accordance with an aspect of the present invention, a shopping cart tablet for use in a retail environment is provided. The shopping cart tablet is adapted for coupling to a product carrying device, such as a shopping cart. The tablet includes a display to display data or other information relating to ordinary operation of the tablet and/or a mobile terminal. For example, software operating on the tablet and/or mobile terminal may provide for the display of pricing information, inventory detail, etc. to a user. Additionally, the display may display a variety of functions that are executable by the tablet and/or mobile terminal. The shopping cart tablet includes a charge cradle for charging the mobile terminal. A plurality of charging intelligence schemes can be employed to charge the mobile terminal.

In accordance with another aspect of the present invention, a mobile terminal is provided. The mobile terminal includes a window in which a bar code reader is able to read a bar code label, or the like, presented to the mobile terminal. The mobile terminal can include a LED that is illuminated to reflect whether the bar code has been properly or improperly read. The mobile terminal also includes a display, which can display information associated with the scanning bar code. Similar to the shopping cart tablet, the mobile terminal display functions to display data or other information relating to ordinary operation of the mobile terminal and/or tablet. The mobile terminal can operate in both a presentation mode of operation and a hand held mode of operation.

In accordance with yet another aspect of the present invention, a shopping cart handle is provided. The shopping cart handle includes a gripping portion and a center portion. The gripping portion is designed such that a when a customer grips the handle, the customer's wrist is angled in a neutral position, which facilitates comfort of the customer while shopping. The center portion comprises an angled portion, or “tongue”, which supports a shopping cart tablet at an angle comfortable for the customer to view. The shopping cart handle also includes a plurality of areas in which at least one label (e.g., instructional, warning, and/or promotional labels) can be placed. The label(s) can be applied to a handle substrate prior to injection of a clear overmold material for durability.

In accordance with yet another aspect of the present invention, a storage rack is provided. The rack can be a modular, multi-configurable rack that is operable to store and/or charge shopping cart tablets and/or mobile terminals. The rack includes a plurality of cradles. The cradles are is modular and are adapted to house at least one shopping cart tablet and/or mobile terminal. The cradles include at least one electrical connection for connecting to at least one of the shopping cart tablet and the mobile terminal. The electrical connection can be employed to charge the shopping cart tablet and/or mobile terminal. The cradles can also include at least one electrical connection for connecting to at least one other cradle. The cradles can be mounted side to side, top to bottom, and/or back to back, if desired.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 illustrates a schematic block diagram of an electronic shopping system in accordance with an aspect of the present invention.

FIG. 2 illustrates a perspective front view of a shopping cart tablet and mobile terminal in accordance with an aspect of the present invention.

FIG. 3 illustrates a perspective back view of a shopping cart tablet and mobile terminal in accordance with an aspect of the present invention.

FIG. 4 illustrates a perspective front view of a mobile terminal in accordance with an aspect of the present invention.

FIG. 5 illustrates a side view of a mobile terminal in accordance with an aspect of the present invention.

FIG. 6 illustrates a perspective back view of a mobile terminal in accordance with an aspect of the present invention.

FIG. 7 illustrates a schematic block diagram of an operation of a shopping cart tablet and/or mobile terminal in accordance with an aspect of the present invention.

FIG. 8 illustrates a block diagram of an electronic shopping system in accordance with an aspect of the present invention.

FIG. 9 illustrates a perspective front view of a shopping cart handle in accordance with an aspect of the present invention.

FIG. 10 illustrates a side view of a shopping cart handle in accordance with an aspect of the present invention.

FIG. 11 illustrates a side view of a shopping cart handle in accordance with an aspect of the present invention.

FIG. 12 illustrates a mounting mechanism for a shopping cart handle in accordance with an aspect of the present invention.

FIG. 13 illustrates a cup holder adapted for a shopping cart in accordance with an aspect of the present invention.

FIG. 14 illustrates a combination of a shopping cart, shopping cart handle, tablet, and mobile terminal in accordance with an aspect of the present invention.

FIG. 15 illustrates a combination of a shopping cart, shopping cart handle, tablet, and mobile terminal in accordance with an aspect of the present invention.

FIG. 16 illustrates a combination of a shopping cart, shopping cart handle, tablet, and mobile terminal in accordance with an aspect of the present invention.

FIG. 17 illustrates a storage/charging cradle for a shopping cart tablet and/or mobile terminal in accordance with an aspect of the present invention.

FIG. 18 illustrates a plurality of storage/charging cradles coupled together in accordance with an aspect of the present invention.

FIG. 19 illustrates a storage/charge rack located in a retail environment in accordance with an aspect of the present invention.

FIG. 20 illustrates a security system for an electronic shopping system in accordance with an aspect of the present invention.

FIG. 21 illustrates a methodology of fabricating a shopping cart tablet in accordance with an aspect of the present invention.

FIG. 22 illustrates a methodology of fabricating a mobile terminal in accordance with an aspect of the present invention.

FIG. 23 illustrates a methodology of fabricating a shopping cart handle in accordance with an aspect of the present invention.

FIG. 24 illustrates a methodology of fabricating a storage/charge cradle in accordance with an aspect of the present invention.

FIG. 25 illustrates a methodology for automatically associating a shopping cart tablet with a mobile terminal in accordance with an aspect of the present invention.

FIG. 26 illustrates a methodology of providing mismatch notification in accordance with an aspect of the present invention.

FIG. 27 illustrates a methodology for mitigating theft of a shopping cart tablet and/or mobile terminal in accordance with an aspect of the present invention.

### DETAILED DESCRIPTION OF THE INVENTION

The present invention relates to systems and methods for a shopping cart tablet. The present invention will now be described with reference to the drawings, wherein like reference numerals are used to refer to like elements throughout. It is to be appreciated that the various drawings are not drawn to scale from one figure to another nor inside a given figure, and in particular that the size of the components are arbitrarily drawn for facilitating the reading of the drawings. In the following description, for purposes of explanation, numerous specific details are set forth in order to provide a thorough understanding of the present invention. It may be evident, however, that the present invention may be practiced without these specific details. In other instances, well-known structures and devices are shown in block form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. For example, it is to be appreciated that certain aspects of the invention can employ inference engines (e.g., classifiers trained explicitly and/or implicitly) to perform a probabilistic-based or statistical-based analysis as to inferring a user's goals or intentions in connection with the shopping system described herein. Thus, a shopping tablet can infer an item potentially desired by a customer based on historical, extrinsic and state information, and perform an action related to the item (e.g., to facilitate sale thereof). Explicit training can be performed on a classifier prior to customer use, and implicit training can be an on-going training process performed by a user/customer, for example.

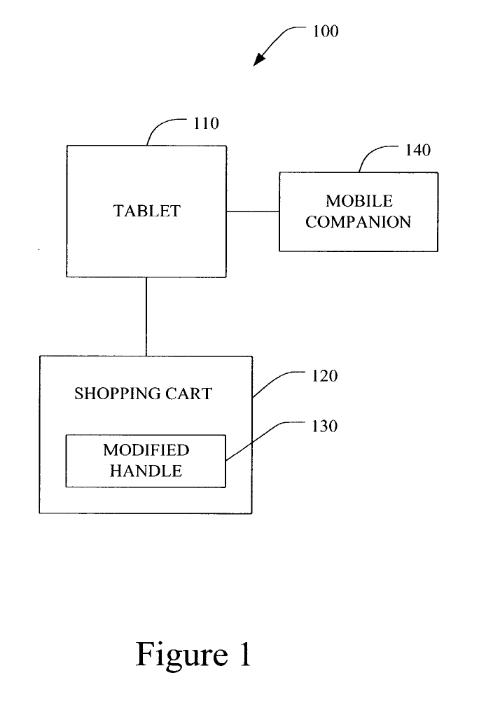

Referring initially to FIG. 1, an electronic shopping system 100 is provided in accordance with an aspect of the present invention. The electronic shopping system 100 comprises a tablet 110 that can be hand-held and/or coupled to a shopping cart 120 or any other suitable product carrying device, such as a hand-held shopping basket. For example, the shopping cart 120 can include a handle 130 adapted to support the tablet 110, such that the tablet 110 can rest on a handle portion of the shopping cart 120. The tablet 110 is adapted to house a mobile terminal 140. The tablet 110 and/or mobile terminal 140 can include a speaker and a graphic interface which manufacturers can use to advertise their products as well as provide information about its products to a customer. Retailers may use the tablet 110 and/or mobile terminal 140 to provide the customer with recipes, store advertisements, nutritional information, etc. Icons can be displayed by the graphical interface to promote the various products. The tablet 110 and/or mobile terminal 140 can also be employed to provide an easy link for the customer to the manufacturer's web site and/or the retailer's website for product information. The mobile terminal 140 can include a barcode scanner to scan a barcode of a merchandise item.

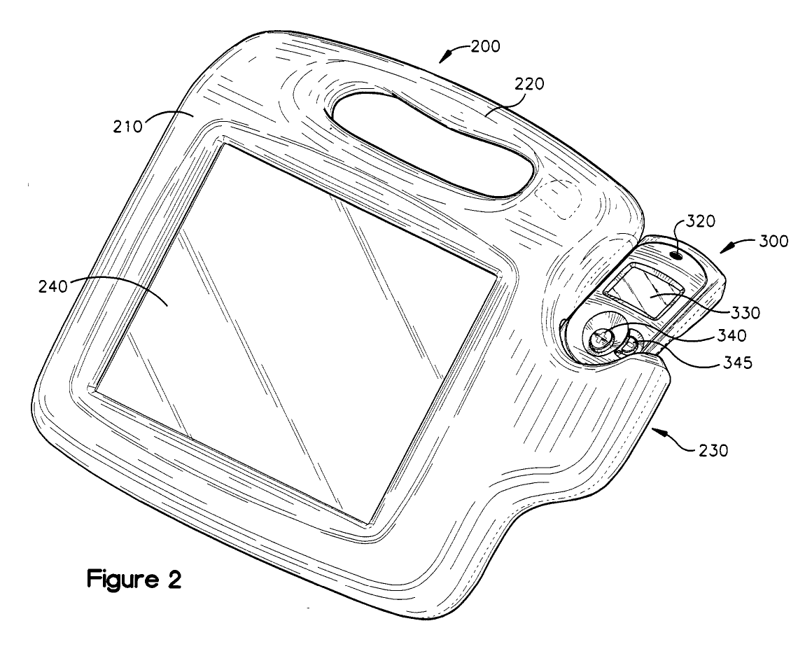

FIG. 2 illustrates an example of a shopping cart tablet 200 and a mobile terminal 300. The shopping cart tablet 200 includes a housing 210, which can be constructed from a high strength plastic, metal, or any other suitable material. The housing 210 is adapted for coupling to a product carrying device, such as a shopping cart, as will be described in further detail below. The housing 210 includes a “lunch-box” style handle 220 for easy removal from a docking station, a shopping cart, or for carrying the tablet 200, for example. The tablet 200 also includes a display 240. As is conventional, the display 240 functions to display data or other information relating to ordinary operation of the tablet 200 and/or mobile terminal 300. For example, software operating on the tablet 200 and/or mobile terminal 300 may provide for the display of pricing information, inventory detail, etc. to a user. Additionally, the display 240 may display a variety of functions that are executable by the tablet 200 and/or mobile terminal 300. The display 240 provides for graphics based alpha-numerical information such as, for example, the price of a product. The display 240 also provides for the display of graphics such as icons representative of particular products, for example. The display 240 can also be a touch screen, which may employ capacitive, resistive touch, infrared, surface acoustic wave, or grounded acoustic wave technology.

Additional features not shown on tablet 200 can include user interface keys, which may include a full alphanumeric keypad, function keys, enter keys, etc; a speaker to transmit and/or receive audio information to and from a user; a printer system for discharging printed paper through a slot in the housing 210; an antenna for wireless communicating information with an RF access point; and an IR transceiver for communicating information with an IR access point. It is to be appreciated that the tablet can include a variety of features customized to a user's needs.

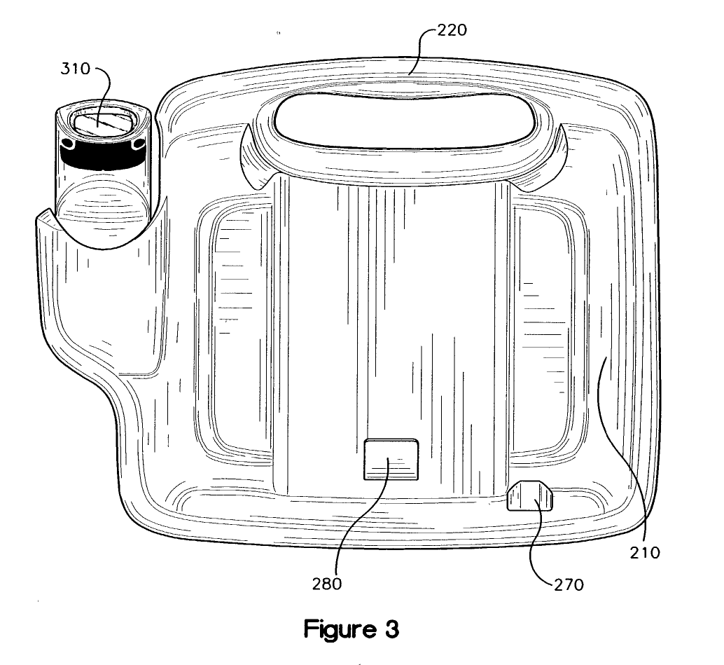

The mobile terminal 300 includes a window 310 (FIG. 3) in which a bar code reader is able to read a bar code label, or the like, presented to the mobile terminal 300. The mobile terminal 300 can include a LED 320 that is illuminated to reflect whether the bar code has been properly or improperly read. Alternatively, or additionally, a sound may be emitted from a speaker (not shown) to alert the user that the bar code has been successfully imaged and decoded. The mobile terminal 300 also includes a display 330, which can display information associated with the scanning bar code. Similar to the shopping cart tablet, the mobile terminal display 330 functions to display data or other information relating to ordinary operation of the mobile terminal 300 and/or tablet 200. For example, software operating on the mobile terminal 300 and/or tablet 200 may provide for the display of pricing information, inventory detail, etc. to a user. Additionally, the display 330 may display a variety of functions that are executable by the mobile terminal 300 and/or tablet 200. The display 330 provides for graphics based alpha-numerical information such as, for example, the price of a product. The display 330 also provides for the display of graphics such as icons representative of particular products, for example. The display 330 can also be a touch screen, which may employ capacitive, resistive touch, infrared, surface acoustic wave, or grounded acoustic wave technology.

The mobile terminal also includes at least one user input key for accepting or rejecting at least on scanned image, such as a bar code. If the scanned image is accepted, the information can be transmitted from the mobile terminal 300 to the tablet 200. For example, the mobile terminal 300 can have two user input keys: a plus key 340 and a minus key 345. When a bar code of an item is scanned, product information can be displayed on the display 330 of the mobile terminal. If the user wishes to add the item to a shopping list, for example, the user can select the plus key 340 and the item information is transmitted to the tablet. However, if the user does not wish to transmit the item information to the tablet, the user can select the minus key 345 and the information will be cleared from the mobile terminal 300.

Alternatively, each of the user input keys 340, 345 can activate a scanning module located inside the mobile terminal 300. When the customer wishes to add a product to the group of items he wants to purchase, he uses the plus key 340 to scan the product bar code. This can automatically transmit the item information to the tablet 200. Then, if the customer decides to return one of the items previously added to the purchased item list, the item bar code is rescanned using the minus key 345. This process deletes the product from the customer's purchase item list inside the tablet's memory. In each case the information regarding the scanned item is displayed on the mobile terminal display 330 and/or the tablet display 240. This information may include the price of the item as well as the quantity of the item on the customer's shopping list.

The shopping cart tablet 200 and/or mobile terminal 300 can also include a smart card slot (not shown), a magnetic stripe reader (not shown), and/or a biometric sensor, such as a thumbprint reader (not shown). Accordingly, a smart card, ID card, and/or a user's biometric data (e.g., iris pattern, fingerprint, facial features) can be employed to provide for storage and retrieval of a customer's personal information, demographic profile, and shopping transaction history data. Alternatively, or additionally, personal information can be provided via a user ID and password, which a customer enters into the shopping cart tablet and/or mobile terminal. Customer identification information can be employed to determine an award of incentive or loyalty points and/or whether the customer is eligible for any special discounts.

Turning now to FIG. 3, a back view of the shopping cart tablet 200 and mobile terminal 300 is depicted. The shopping cart tablet housing 210 may be comprised of a number of shell portions such as for example front and rear shells (not shown) as well as a battery compartment cover (not shown). Accordingly, the tablet housing 210 is adapted for easy disassembly to accommodated repair and replacement of parts such as batteries and/or lights, for example. The shopping cart tablet 200 also includes at least one electrical contact 270 for coupling to a docking station, as will be described in further detail below.

When lithium battery cells are employed in the shopping cart tablet 200, charging and discharging must be regulated. When a lithium cell is charged for too long or when a lithium cell is charged with too much energy, the lithium can release combustible gasses at very high temperatures, which can lead to fire, explosion, and injury to the user. Thus, the shopping cart tablet 200 can include a battery protection circuit scheme that can sense charge and discharge rates, as well as cell voltage and temperature. If an anomaly is detected (e.g., excessively high charge or discharge current levels, high cell voltage levels, high cell temperature, etc.), the protection circuitry will open. The open circuit operates to isolate the cell from external battery terminals, which protects people and equipment. Low drain to source resistance transistors can be connected in series with the battery cells as pass elements. The transistors open under fault conditions.

The tablet housing 210 also includes a battery operated cradle 230 for docking the mobile terminal 300. Accordingly, the mobile terminal 300 can be charged via a tablet battery and/or tablet power source without being powered into an external power source. A plurality of charging intelligence schemes can be employed between the tablet 200 and the mobile terminal 300. For example, the battery charge states between the tablet 200 and the mobile terminal 300 can be correlated such that both the battery in the tablet 200 and the battery in the mobile terminal 300 can have substantially the same amount of usable life left at any given time. As another example, the mobile terminal 300 will not be permitted to charge when the tablet battery charge state is below a predetermined threshold and the mobile terminal battery charge is above a predetermined threshold. As yet another example of a charging intelligence scheme, the mobile terminal 300 will not be permitted to charge when the mobile terminal's battery state reaches full capacity. It is to be appreciated that any other suitable charging intelligence scheme can be employed and is contemplated as falling within the scope of the present invention.

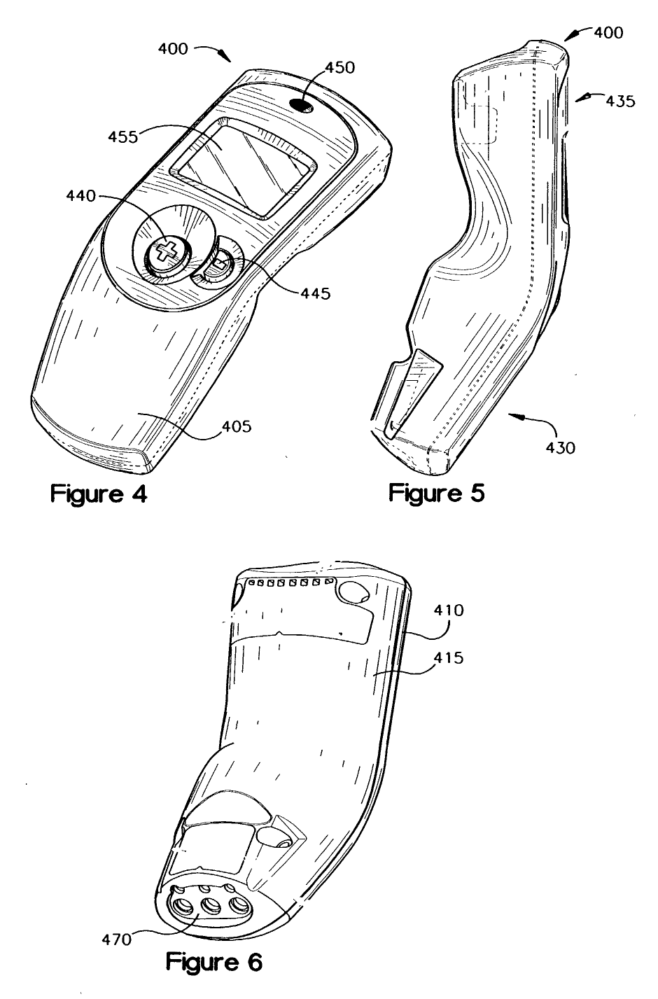

FIGS. 4-6 depict a mobile terminal 400 in accordance with an aspect of the present invention. The mobile terminal 400 includes a housing 405, which can be fabricated from a high strength plastic, metal, or any other suitable material. The mobile terminal housing 405 can include a number of shell portions such as for example front and rear shells 410 and 415. The mobile terminal housing 405 includes a manually graspable handle portion 430 and a head portion 435 (FIG. 5). The shape of the mobile terminal housing 405 facilitates an ergonomically suitable handheld terminal, as well as, a proper scanning position of the terminal 400 when mounted in a shopping cart tablet. At least one button, preferably two buttons 440 and 445 are included in the mobile terminal 400, which can be easily accessed by a thumb of a user while gripping the handle portion 430 of the mobile terminal 400. The buttons 440 and 445 can include a scan button for activating a scanning unit inside the mobile terminal 400. An indicator light 450 such as a multicolor LED, can also be included to indicate an operational mode of the mobile terminal 400. For example, if a barcode has been successfully read, the indicator light 450 can illuminate green, if a barcode is not successfully read or the mobile terminal 400 does not recognize the barcode, the indicator light 450 can illuminate red.

As an alternative, or in addition to the at least one button 440 and 445, the mobile terminal 400 can include a touch pad (not shown) which is of the type that may, for example, control scrolling of information on a display 455, and also provide selection of functions or features. Alternatively, manual key activation could also be provided by a touch screen display having software defined user interface buttons which could be configured to provide user input commands. Alternatively, a thumbwheel (not shown) could be provided to scroll through various options and select a desired command or field. The thumbwheel would have a rotating function for scrolling in one of two directions and be capable of pressing to select a specific selection once it is selected.

The mobile terminal can employ a two-dimensional imaging assembly. The imaging assembly includes a two-dimensional photosensor and an optic assembly supported in a lens housing or shroud for focusing an image of a dataform, for example, in a field of view onto the photosensor array. Conventionally available circuitry on printed circuit boards operate to sequentially read out charges accumulating on photosensors of the photosensor array, generate an analog composite video signal, store a digital representation of a captured image, and decode the captured image to generate the decoded data signal. At least a portion of this image capture, image processing, and decoding circuitry may be implemented in code executed by a processor on the printed circuit board. The illumination assembly of the mobile terminal can include four sets of illumination light emitting diodes (LEDs) (not shown), which can be positioned on a printed circuit board. The illumination LEDs direct illumination through corresponding aligned lens portions of a lens array towards the imaging field of view. Two targeting LEDs operate to direct illumination through aligned apertures in board and through aligned lens portion in the lens array and generate the cross hair illumination pattern in the field of view to assist the operator in relatively positioning the mobile terminal and the dataform. As noted above, the cross hair illumination pattern is generated when the mobile terminal is used in the hand held mode.

The mobile terminal housing 405 can also support a speaker (not shown) which can be driven by audio indicator driver circuitry mounted on the control printed circuit board. The speaker can be employed to provide audio feedback suitably in the form of a ½ second beep, for example, to the customer to indicate a successful bar code dataform read and decode.

FIG. 6 depicts a back view of the mobile terminal 400 in accordance with an aspect of the present invention. Batteries (not shown) for the mobile terminal 400 can be located within the body of the terminal 400, rather than being located within a conventional battery compartment. Accordingly, the weight and size of the mobile terminal 400 is distributed over the body of the terminal 400, thereby facilitating ease of gripping and/or holding of the mobile terminal 400. However, it is to be appreciated that the mobile terminal 400 can alternatively, or additionally, include any number of battery compartments, including one, and is contemplated as falling within the scope of the present invention.

The mobile terminal 400 can also include a battery protection circuit scheme that can sense charge and discharge rates, as well as cell voltage and temperature. If any anomaly is detected (e.g., excessively high charge or discharge current levels, high cell voltage levels, high cell temperature, etc.), the protection circuitry will open. The open circuit operates to isolate the cell from external battery terminals, which protects people and equipment. Low drain to source resistance transistors can be connected in series with the battery cells as pass elements. The transistors open under fault conditions.

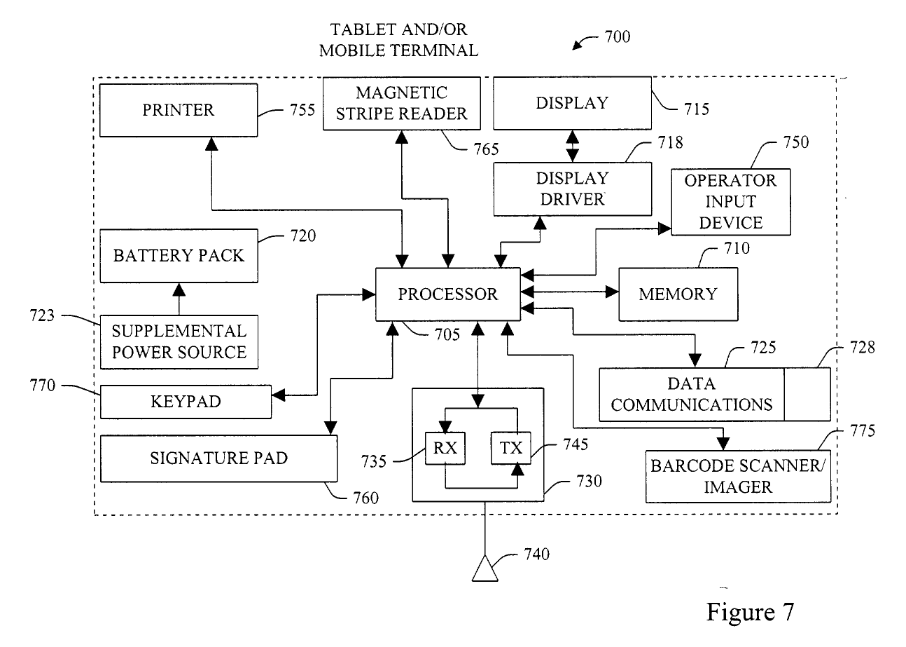

Turning now to FIG. 7, a schematic representation according to one aspect of the present invention is shown in which a processor 705 is responsible for controlling the general operation of a shopping cart tablet and/or mobile terminal 700. The processor 705 is programmed to control and operate the various components within the shopping cart tablet and/or mobile terminal 700 in order to carry out the various functions described herein. The processor or CPU 705 can be any of a plurality of suitable processors. The manner in which the processor 705 can be programmed to carry out the functions relating to the present invention will be readily apparent to those having ordinary skill in the art based on the description provided herein.

A memory 710 tied to the processor 705 is also included in the shopping cart tablet and/or hand-held mobile terminal 700 and serves to store program code executed by the processor 705 for carrying out operating functions of the shopping cart tablet and/or hand-held mobile terminal 700 as described herein. The memory 710 also serves as a storage medium for temporarily storing information such as receipt transaction information and the like. The memory 710 is adapted to store a complete set of the information to be displayed. According to one aspect, the memory 710 has sufficient capacity to store multiple sets of information, and the processor 705 could include a program for alternating or cycling between various sets of display information.

A display 715 is coupled to the processor 705 via a display driver system 720. The display 715 may be a liquid crystal display (LCD) or the like. In this example, the display 715 is a ¼ VGA display with 16 levels of gray scale. The display 715 functions to display data or other information relating to ordinary operation of the shopping cart tablet and/or hand-held mobile terminal 700. For example, the display 715 may display a set of customer information, which is displayed to the operator and may be transmitted over a system backbone (not shown). Additionally, the display 715 may display a variety of functions that control the execution of the shopping cart tablet and/or mobile terminal 700. The display 715 is capable of displaying both alphanumeric and graphical characters. Power is provided to the processor 705 and other components forming the shopping cart tablet and/or hand-held mobile terminal 700 by at least one battery 725. In the event that the battery(s) 725 fails or becomes disconnected from the shopping cart tablet and/or mobile terminal 700, a supplemental power source 730 can be employed to provide power to the processor 705. The shopping cart tablet and/or mobile terminal 700 may enter a minimum current draw of sleep mode upon detection of a battery failure.

The shopping cart tablet and/or mobile terminal 700 includes a communication subsystem 735 that includes a data communication port 740, which is employed to interface the processor 705 with the main computer. The shopping cart tablet and/or mobile terminal 700 also optionally includes an RF section 745 connected to the processor 705. The RF section 745 includes an RF receiver 750, which receives RF transmissions from the main computer for example via an antenna 755 and demodulates the signal to obtain digital information modulated therein. The RF section 745 also includes an RF transmitter 760 for transmitting information to the main computer, for example, in response to an operator input at a operator input device 765 (e.g., keypad) or the completion of a transaction. Peripheral devices, such as a printer 770, signature pad 775, and magnetic stripe reader 780, and an additional barcode scanner/imager 785 can also be coupled to the shopping cart tablet and/or mobile terminal 700 through the processor 705.

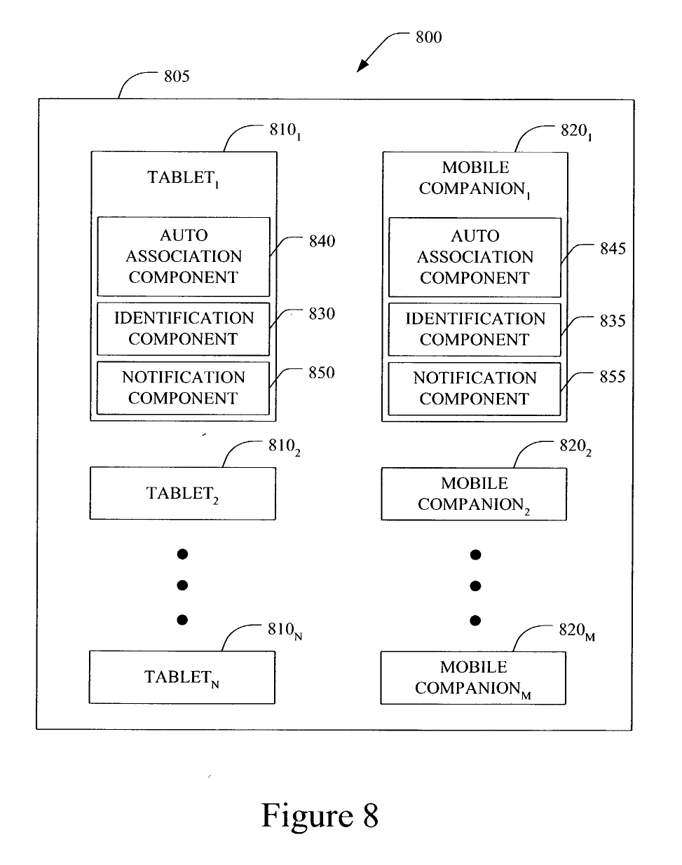

Turning now to FIG. 8, a schematic block diagram of an electronic shopping system 800 is provided. The electronic shopping system 800 includes retail environment 805, which includes a shopping cart tablet 810₁ through a shopping cart tablet 810_{N} and a mobile terminal 820₁ through a mobile terminal 820_{M}, N and M being integers greater than or equal to one. The shopping cart tablets 810₁ through 810_{N} will be collectively referred to as 810; and the mobile terminals 820₁ through 820_{M} will be collectively referred to as 820. The shopping cart tablet(s) 810 and the mobile terminal(s) 820 include an identification component 830 and 835, respectively, which provide the shopping cart tablet(s) 810 and the mobile terminal(s) 820 with unique IDs. At least one of the shopping cart tablet(s) 810 and/or the mobile terminal(s) 820 can also include an auto association component 840 and/or 845 that associates at least one tablet(s) 810 with at least one mobile terminal(s) 820. Accordingly, when a mobile terminal(s) 820 is coupled to a shopping cart tablet(s) 810, the mobile terminal(s) 820 and/or the shopping cart tablet(s) 810 serially sends its unique ID information to the shopping cart tablet(s) 810 and/or the mobile terminal(s), respectively. The ID information is employed by the shopping cart tablet(s) 810 and/or the mobile terminal(s) 820 to automatically associate itself with the mobile terminal(s) 820 and/or the shopping cart tablet(s) 810. The association can be exclusive or the shopping cart tablet(s) 810 and/or the mobile terminal(s) 820 can have a plurality of associations. The auto association component 840, 845 facilitates dynamic reconfiguration of the shopping cart tablet(s) 810 with the mobile terminal(s) 820, and/or vice versa; and thus, mitigates the need for manually setting an association between the shopping cart tablet(s) 810 and the mobile terminal(s) 820.

At least one notification component 850, 855 can also be included in at least one of the shopping cart tablet(s) 810 and/or mobile terminal(s) 820. The notification component 850, 855 can be employed to notify at least one of the shopping cart tablet(s) 810 and/or the mobile terminal(s) 820 of incorrect docking of the mobile terminal(s) 820 within a charge cradle of the shopping cart tablet(s) 810. When a mobile terminal(s) 820 is docked within the charge cradle, at least one of the shopping cart tablet(s) 810 and the mobile terminal(s) 820 sends its ID information to the other device. The shopping cart tablet(s) 810 and/or the mobile terminal(s) 820 can determine whether the tablet(s) 810 is properly associated with an assigned mobile terminal(s) 820. The notification component 850, 855 can alert a user of any mismatch via a message, sound, light, or any other suitable alert mechanism. Additionally, the notification component 850, 855 can alert a system administrator of any mismatch via an email notification, for example.

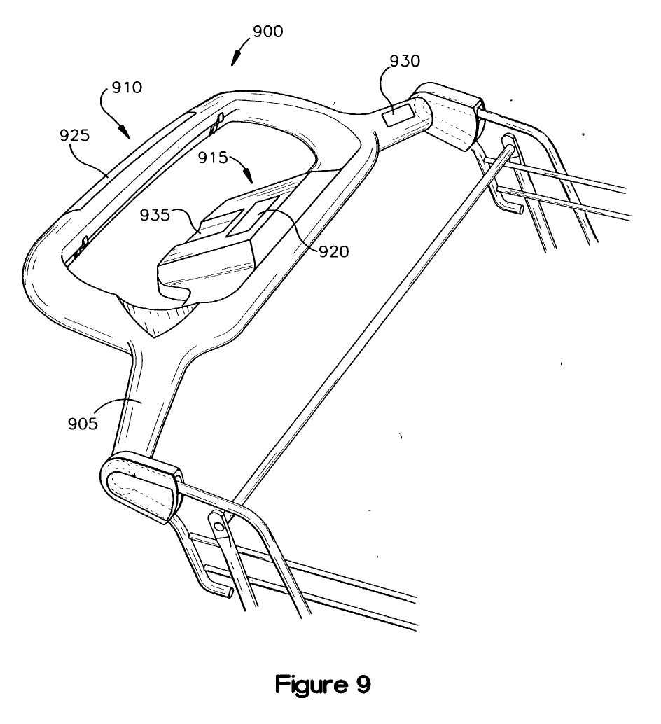

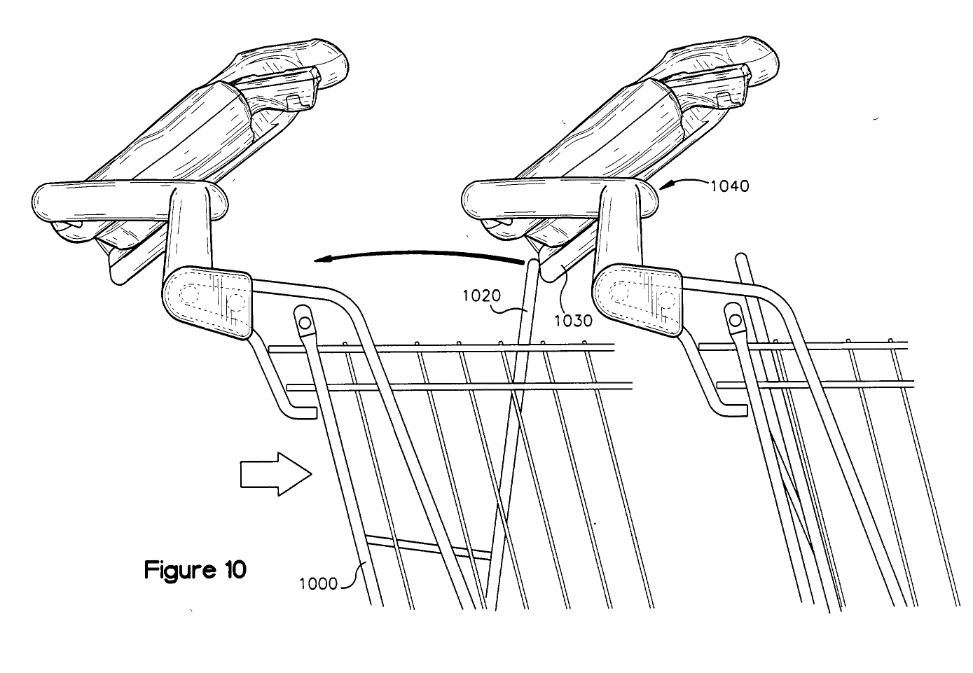

FIG. 9 depicts a shopping cart handle 900 in accordance with an aspect of the present invention. The shopping cart handle 900 includes a gripping portion 905 and a center portion 910. The gripping portion 905 is designed such that a when a customer grips the handle 900, the customer's wrist is angled in a neutral position, which facilitates comfort of the customer while shopping. The center portion 910 comprises an angled portion, or “tongue”, 915 which supports a shopping cart tablet at an angle comfortable for the customer to view. The shopping cart handle 900 also includes a plurality of areas in which at least one label (e.g., instructional, warning, and/or promotional labels) can be placed. For example, the shopping cart handle 900 can include a first label area 920 for a tablet insertion instructional label; and a second label area 925 for a branding label (e.g., a retail store name, a product name). If a cup holder, as described in further detail below, is coupled to the shopping cart, a third label area 930 can be included for a hot beverage warning label. The labels can be applied to a handle substrate prior to injection of a clear overmold material for durability. Employing a substantially transparent overmold material, such as polycarbonate, for example, mitigates user wear on any logos and/or legends that can be applied to the shopping cart handle 900.

The tongue portion 915 of the shopping cart handle includes a passive locking mechanism 935, which can secure the shopping cart tablet to the handle 900 and still allow for easy removal of the shopping cart tablet from the handle 900. The passive locking mechanism 935 includes a recess on a center area of the tongue portion 915. However, it is to be appreciated that the passive locking mechanism can be employed in any suitable area for coupling the shopping cart tablet to the handle 900. Turning back to FIG. 3, the shopping cart tablet 200 includes a projection 280 in a central back portion of the shopping cart tablet housing 210. The projection 280 corresponds with the recess in the shopping cart handle 900. Accordingly, the mating projection and recess features mitigate the tablet from easily decoupling from the handle 900. For example, the locking mechanism 935 mitigates the tablet from being pulled out easily by a child in a child seat. Additionally, the locking mechanism 935 mitigates the tablet from falling out of the handle 900 in a head-on cart collision. It is to be appreciated that any suitable locking mechanism (e.g., passive, aggressive, permanent, non-permanent) can be employed for coupling the shopping cart tablet to the handle 900.

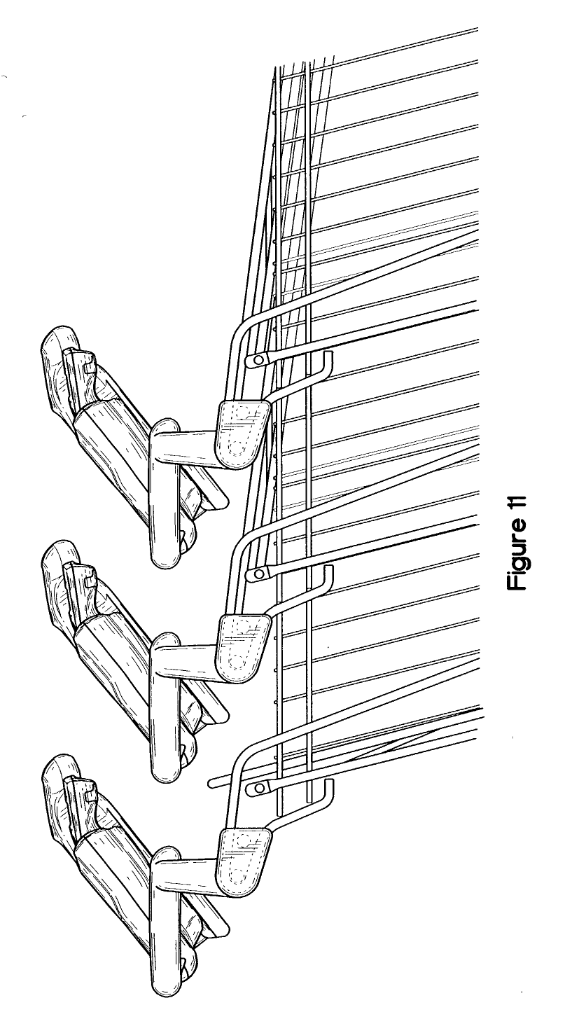

The shopping cart handle 900 is also designed to facilitate nesting of a plurality of shopping carts during storage. For example, the center portion 915 of the shopping cart handle 900 is raised high enough to mitigate interference of the handle 900 and a nested cart (see FIG. 11). The shopping cart handle 900 is also designed such that it allows for the use of a child seat of the cart and/or for the use of a baby bassinette on the shopping cart. Further, the tongue portion 915 of the shopping cart handle 900 is designed to close the child seat of an approaching cart. For example, see FIG. 10. In FIG. 10 a first cart 1000 is being nested into a second cart 1010; the first cart 1000 has its child seat 1020 open. The tongue portion 1030 of a shopping cart handle 1040 on the second cart 1010 is adapted to close the open child seat 1020 during the nesting process (FIG. 11).

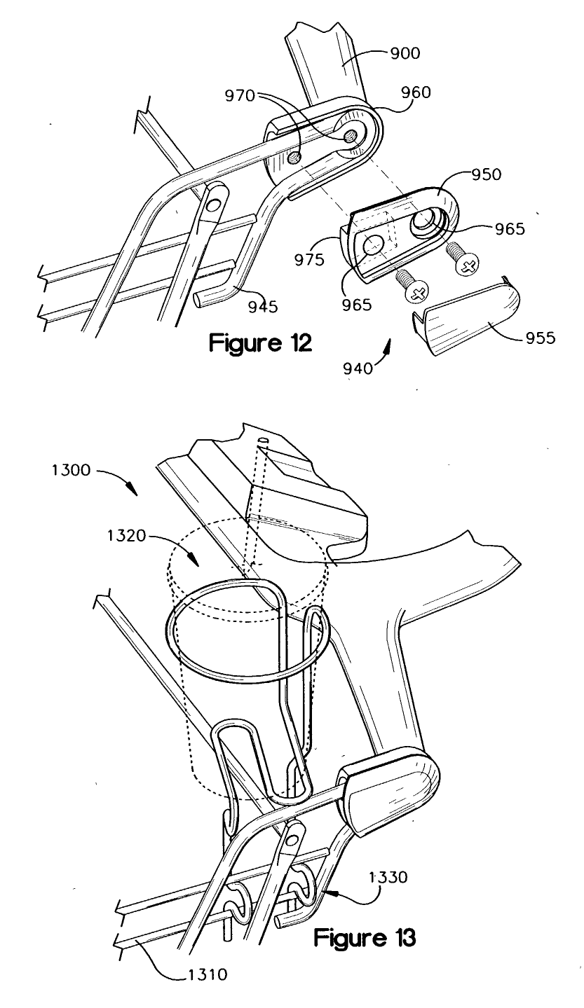

The shopping cart handle 900 also includes an attachment mechanism 940 for attaching the handle 900 to a shopping cart 945, as depicted in FIG. 12. The attachment mechanism 940 includes at least one endcap 950 and optionally, at least one endcap cover 955. The shopping cart handle 900 includes at least one flange portion 960, preferably two flange portions located at opposing ends of the handle 900. The flange(s) 960 is adapted to fit adjacent to, partially cover, or cover a portion of the shopping cart frame 945. The endcap(s) 950 is adapted to mate with the flange(s) 960. Both the endcap(s) 950 and the flange(s) 960 include at least one bore 965, 970 for coupling the mating parts 950, 960. The bores 965, 970 can be threaded or non-threaded and a conventional screw and/or nut and bolt assembly can be employed to couple the endcap(s) 950 and the flange(s) 960 and secure the shopping cart handle 900 to the shopping cart 945. The endcap(s) 950 can also include an anti-torque wedge 975 for mitigating torque on the attachment mechanism 940. The endcap cover(s) 955 can be snapped onto an exposed portion of the endcap(s) 950 to hide the screw(s) and/or bolt(s) utilized to secure the shopping cart handle 900 to the shopping cart 945.

Although employing the shopping cart tablet and mobile terminal have been described herein as being employed with the shopping cart handle; it is to be appreciated that the shopping cart tablet and mobile terminal can be coupled to a conventional shopping cart without the shopping cart handle described herein.

FIG. 13 illustrates a cup holder 1300 for a shopping cart 1310 in accordance with an aspect of the present invention. The cup holder 1300 can be fabricated from a wire and includes a receptacle portion 1320, which is adapted to hold a plurality of different sizes of cups. The cup holder 1300 can also be plastic, rubber, or any other suitable material for supporting hot and/or cold beverages while the customer is shopping. The cup holder 1300 can also include a mounting portion 1330 for securing the cup holder 1300 to a frame portion of the shopping cart 1310. The mounting portion 1330 includes spring features, which can be integrated into at least a portion of the cup holder 1300. Depending on the strength of the spring features, the cup holder 1300 can be easily removed from the shopping cart 1310 or can be substantially fixed in place. Alternatively, a mounting portion having a plate and fasteners to “sandwich” a cup holder wireframe to a shopping cart wireframe can be employed. However, it is to be appreciated that any suitable mounting mechanism can be employed to secure the cup holder to the shopping cart frame.

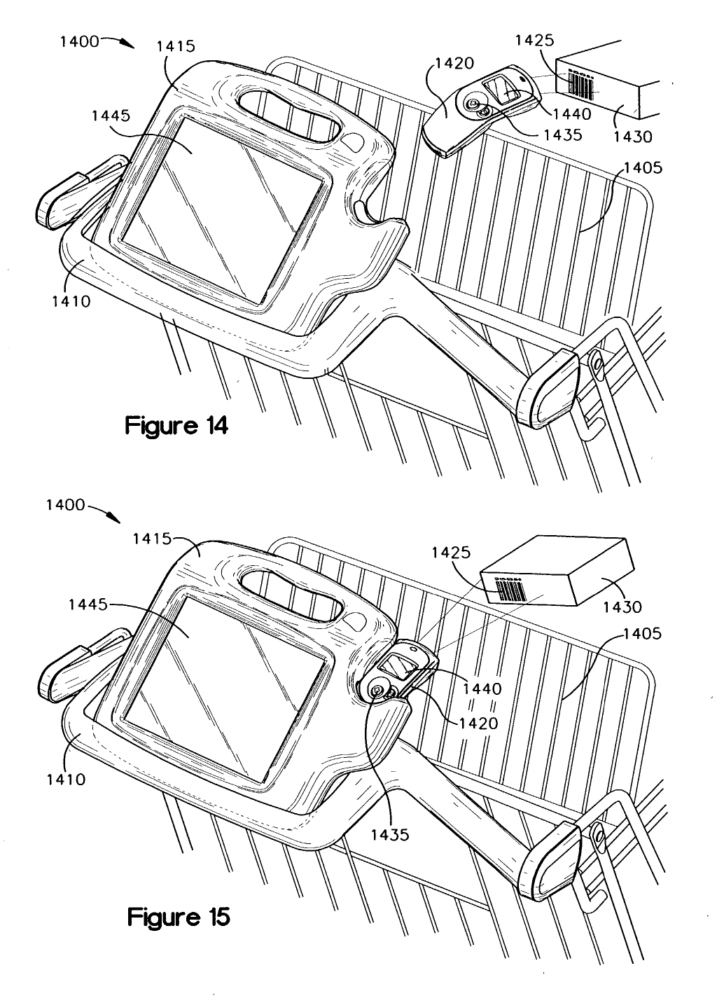

FIG. 14 depicts an electronic shopping system 1400 in accordance with an aspect of the present invention. The electronic shopping system 1400 includes a shopping cart 1405 having a shopping cart handle 1410 coupled thereto. The shopping cart handle 1410 is adapted to support a shopping cart tablet 1415 and/or a mobile terminal 1420. A cup holder (not shown) can also be coupled to the shopping cart 1405 for user convenience.

The mobile terminal 1420 is adapted to operate in at least two modes: a) a hand held mode; and b) a presentation mode. The hand held mode of operation is represented in FIG. 14, wherein the mobile terminal 1420 is removed by the customer from a charge cradle of the shopping cart tablet 1415. When supported in the charge cradle, the mobile terminal 1420 extends slightly beyond the tablet housing so that the customer can easily grasp a front portion of the mobile terminal 1420 and slide it out of the charge cradle. The customer moves the mobile terminal 1420 to a dataform 1425 of an item 1430 so desired to be purchased or priced by the customer. The customer activates a suitable selector, such as depressing a button 1435 on the mobile terminal 1420 to actuate an imaging assembly (not shown) and an illumination assembly (not shown) of the mobile terminal 1420. The illumination assembly advantageously provides a substantially uniform illumination pattern that substantially corresponds to an imaging area or field of view of the imaging assembly and additionally generates a more intense cross hair illumination pattern to aid the customer in positioning the mobile terminal 1420 so that the dataform 1425 of an item 1430 is properly within the imaging area of the mobile terminal 1420.

The substantially uniform illumination pattern and cross hair aiming pattern are rapidly alternated between off and on states, such that one is off while the other is on. This alternation of illumination patterns avoids the difficulty of having to decode a captured dataform image which has intense cross hair illumination patterns imposed thereon. The alternation of the illumination and cross hair patterns is rapid enough that it appears to the customer that the cross hair aiming pattern is continuously on.

While keeping the button 1420 depressed, the customer aims the cross hair pattern at the dataform 1425. The customer moves the mobile terminal 1420 toward the item 1430 until an audible tone or “beep” is emitted by a speaker of the mobile terminal and/or shopping cart tablet 1415 indicating the dataform 1425 has been successfully read and decoded. The item's price, product name or description and product size will appear on a display 1440 of the mobile terminal 1420 and/or a display 1445 of the shopping cart tablet 1415. After the beep is heard, the mobile terminal 1420 is returned to the charge cradle and slid into the housing of the shopping cart tablet 1415.

In the presentation mode of operation shown in FIG. 15, the mobile terminal 1420 is disposed in the charge cradle and the customer reads a dataform 1425 affixed to an item 1430 by moving the item 1430 to the mobile terminal 1420. While the mobile terminal 1420 remains in the charge cradle, a magnetic switch enclosed in a back portion of the mobile terminal housing is turned on by a magnet positioned in the shopping cart tablet housing. Actuation of the magnetic switch causes the imaging assembly and the illumination assembly to remain actuated. Thus, the mobile terminal 1420 is continuously able to read a dataform when it is disposed in the charge cradle. When a “beep” is heard, the customer knows that the dataform has been successfully imaged and decoded. In this presentation mode, the illumination pattern is continuously on and the cross hair illumination pattern is deactivated since properly aiming the mobile terminal 1420 is not a concern. A customer will typically pass an item by the mobile terminal 1420 to read a code much like a cashier passes an item over a common countertop scanner. The hand held mode is advantageously used when an item on a shelf is too large or too clumsy to move from the shelf or if the customer just wishes to check a price without removing the item from the shelf. The presentation mode is advantageously employed when a selected item is smaller and more easily handled.

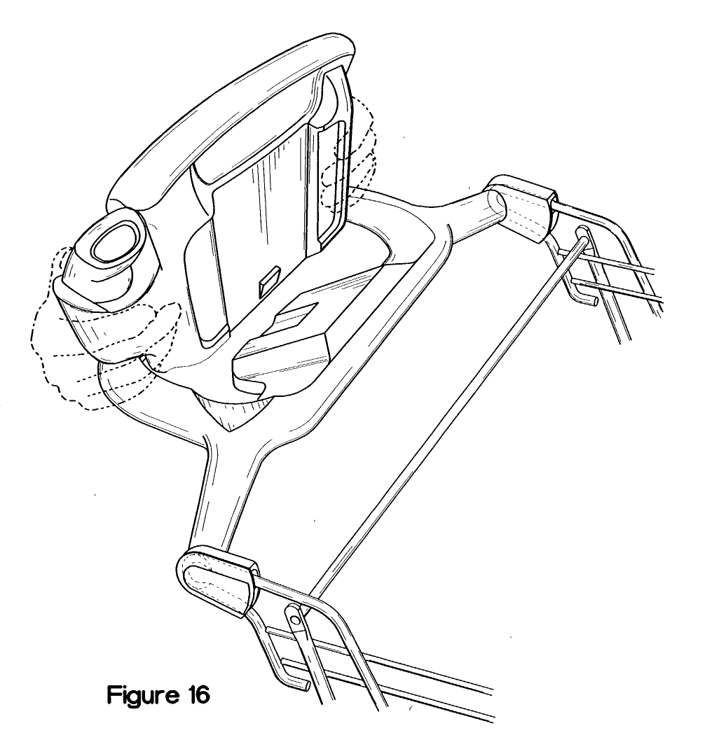

The shopping cart tablet and mobile terminal assembly is also easily removable from the shopping cart handle, as illustrated in FIG. 16. Accordingly, a user can employ the electronic shopping system when shopping without a shopping cart.

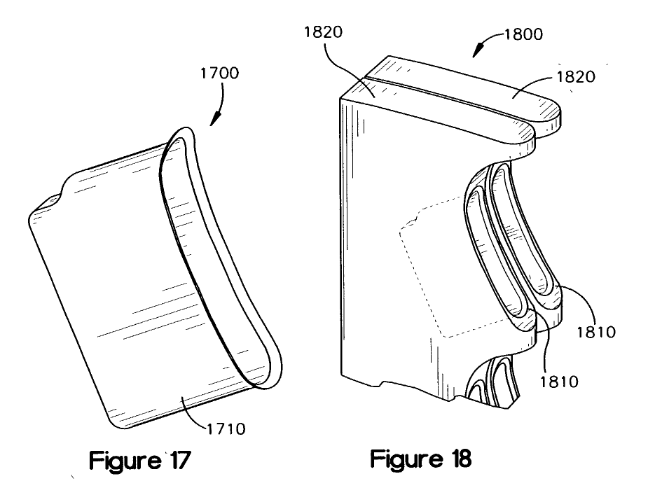

Shopping cart tablets and mobile terminals, as described herein, can be housed in a storage and/or charge rack located in the retail environment. The rack can be a modular, multi-configurable rack that is operable to store and/or charge shopping cart tablets and/or mobile terminals. The rack includes a plurality of cradles. Turning now to FIG. 17, an example of a cradle 1700 is illustrated. A housing 1710 of the cradle 1700 can be fabricated from a high strength plastic, metal, or any other suitable material. The cradle 1700 is modular and is adapted to house at least one shopping cart tablet (not shown) and/or mobile terminal (not shown). The cradle 1700 includes at least one electrical connection for connecting to at least one of the shopping cart tablet and the mobile terminal. The electrical connection can be employed to charge the shopping cart tablet and/or mobile terminal. The cradle 1700 can also include at least one electrical connection for connecting to at least one other cradle.

Turning now to FIG. 18, a plurality of docking stations 1800 can be coupled together for storing and/or charging a plurality of shopping cart tablets (not shown) and/or mobile terminals (not shown). The docking stations 1800 include a plurality of cradles 1810 and cradle housings 1820. The cradle housings 1820 can include at least one connector element for coupling the housings 1820 together. Alternatively, connections in the cradles 1810 can be employed to couple the docking stations 1800 together. The docking stations 1800 can be mounted in any configuration suitable for physical layout of a storage and/or charging rack in a retail environment. For example, the docking stations 1800 can be mounted side to side, top to bottom, and/or back to back, if desired.

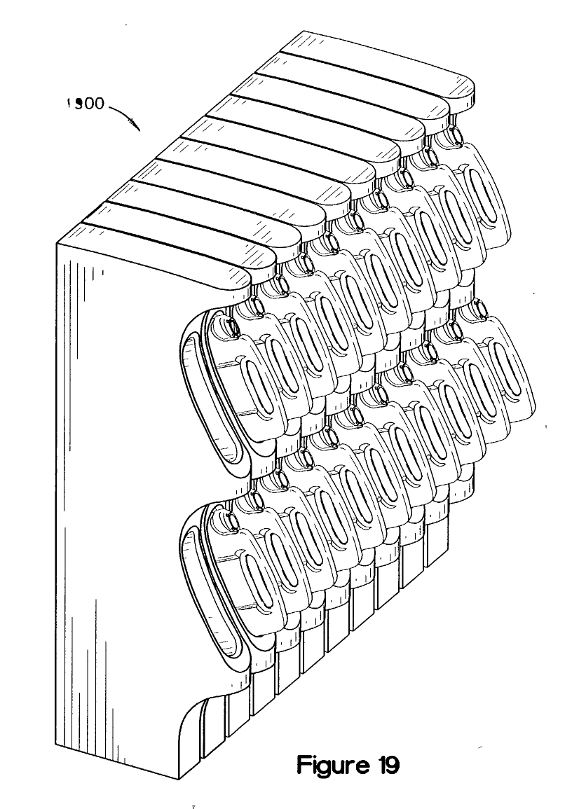

FIG. 19 illustrates an example of a storage and/or charging rack 1900 for a plurality of shopping cart tablets and/or mobile terminals. Electrical connections (not shown) can be included on the rack 1900 to transmit information between the shopping cart tablet and/or the mobile terminal and the rack 1900. For example, the rack 1900 can include a smart charge system. The system can recognize in which rack 1900 and/or cradle a particular shopping cart tablet and/or mobile terminal is residing. Identification information can be passed from the rack slot to the tablet and/or mobile terminal electronically upon insertion of the tablet and/or mobile terminal. Additionally, or alternatively, identification information from the shopping cart tablet and/or mobile terminal can be passed to the rack 1900 and/or cradle upon insertion of the tablet and/or mobile terminal.

Alternatively, the rack can include one unit with a plurality of electrical connections for storing and/or charging a plurality of tablets and/or mobile terminals; and/or the rack can include a plurality of units wherein each unit has a plurality of electrical connections for communication and/or for charging a plurality of tablets and/or mobile terminals. It is to be appreciated that although the rack and cradles have been described herein as being adapted to charge the shopping cart tablet and/or mobile terminal. The rack and cradles may simply be a storage place for the shopping cart tablet and/or mobile terminal and does not necessarily require charge functionality.

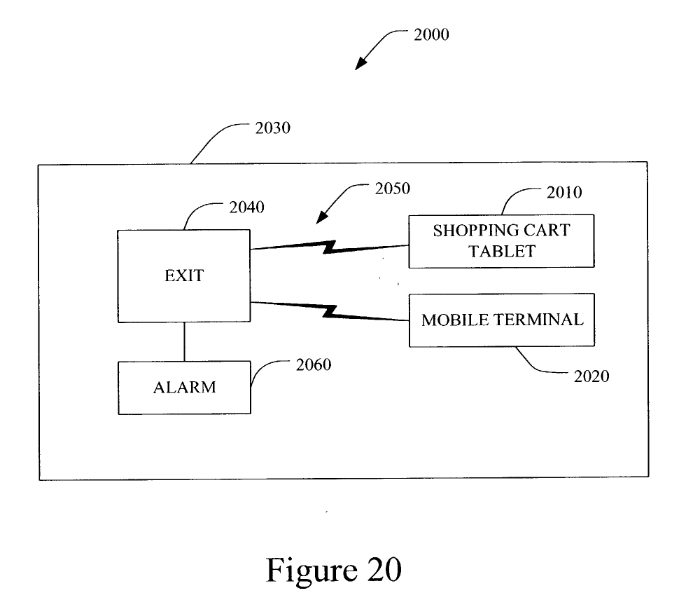

FIG. 20 depicts a security system 2000 in accordance with an aspect of the present invention. A shopping cart tablet 2010 and/or a mobile terminal 2020 located within a retail environment 2030 can be coupled to the security system 2000 to prevent theft of the shopping cart tablet 2010 and the mobile terminal 2020. For example, a wireless system can be installed at or within a close proximity to at least one exit 2040 in the retail environment 2030. As the shopping cart tablet 2010 and/or the mobile terminal 2020 enter or come within close proximity of the wireless system, the wireless ID of the shopping cart tablet 2010 and/or mobile terminal 2020 is interrogated via at least one communication channel 2050. The shopping cart tablet 2010 and/or mobile terminal 2020 can communicate via a transceiver or communication can occur directly with at least one access point of the retail environment 2030. Upon detection of the wireless ID(s), the wireless ID(s) is compared to a database or list of known “in-store” devices. If the detected ID(s) matches an “in-store” device, an alarm 2060 will sound to provide notification that at least one shopping cart tablet 2010 and/or mobile terminal 2020 is about to leave the retail environment 2030. If, on the other hand, the detected ID(s) does not match an “in-store” device listed in the database, the alarm 2060 will not be activated.

The security system 2000 can employ a BlueTooth communication protocol. The shopping cart tablet 2010 and/or the mobile terminal 2020 can include BlueTooth radios. The BlueTooth ID of the shopping cart tablet 2010 and/or the mobile terminal 2020 can be interrogated at or near at least one exit 2040 of the retail environment 2030. Bluetooth is a Radio Frequency (RF) specification for short-range, point to multi-point voice and data transfers. Bluetooth can transmit through solid, non-metal objects. It has a nominal link range from 10 centimeters to 10 meters, but can be extended to 100 meters by increasing the transmit power. It is based on short-range radio links and facilitates ad hoc connections for stationary and mobile communication environments. The Bluetooth standard is a low cost, short-range wireless communication standard that typically operates in the 2,400-2,483.5 MHz industrial, scientific and medical (ISM) band. The ISM band is available worldwide and allows unlicensed operation of spread spectrum systems. The Bluetooth standard is often employed for short distance connections and can be employed to replace cables used today that, for example, connect laptops to cellular telephones, printers, desktops, fax machines, joysticks and many other digital devices that can be part of the Bluetooth system. Bluetooth can also provide a bridge to existing data networks. Bluetooth is specifically designed to provide low-cost, robust, efficient, high capacity, ad hoc voice and data networking.

Bluetooth technology has been designed to operate in noisy radio frequency environments and uses a fast acknowledgment and frequency hopping scheme to make a robust communications link. Bluetooth radio modules attempt to avoid interference from other signals by hopping to a new frequency after transmitting or receiving a packet as compared to other systems operating at the same frequency band. The implementations of faster hops and shorter packets limit impact of microwave and other sources of interference. Bluetooth uses forward error correction to limit impact of random noise on longer distance links.

The Bluetooth specification employs frequency hopping spread spectrum techniques. The Bluetooth specification further provides a standard method data transmission between Bluetooth devices employing, for example, RFComm, OBEX, Service Discovery Protocol and/or logical link control and adaptation protocol. Another example of a frequency hopping spread spectrum wireless communications protocol is ConnexRF by AeroComm. It is to be appreciated that alternative frequency adjusting wireless communication protocols (e.g., to achieve improved noise immunity) are also encompassed within the present invention (e.g., direct sequence spread spectrum).

It is to be appreciated that any suitable communication protocol can be employed. For example, the network can employ Ethernet (IEEE 802.3), Wireless Ethernet (IEEE 802.11), PPP (point-to-point protocol), point-to-multipoint short-range RF (Radio Frequency), WAP (Wireless Application Protocol), IP, IPv6, TCP and User Datagram Protocol (UDP). Further, the network connection can be via an extranet and/or a shared private network. For example, the network connection can be via a phone connection (not shown) from the shopping cart tablet 2010 and/or mobile terminal 2020 to an Internet Service Provider (ISP) to the security system 2000. Another possible network connection is via a Local Area Network (LAN) to the security system 2000. It is noted that the shopping cart tablet 2010 and/or mobile terminal 2020 can communicate over a separate and isolated network from the security system network. Information exchanged between and among the shopping cart tablet 2010 and/or mobile terminal 2020 and the security system 2000 can be in a variety of formats and can include, but is not limited to, such technologies as HTML, SHTML, VB Script, JAVA, CGI Script, JAVA Script, dynamic HTML, PPP, RPC, TELNET, TCP/IP, FTP, ASP, XML, PDF, EDI, WML as well as other formats.

At least one of the shopping cart tablet and mobile terminal can also include a system, such as a global positioning system (GPS), for determining a location of the shopping cart tablet and/or mobile terminal and for transmitting information to and from the shopping cart tablet and/or mobile terminal.

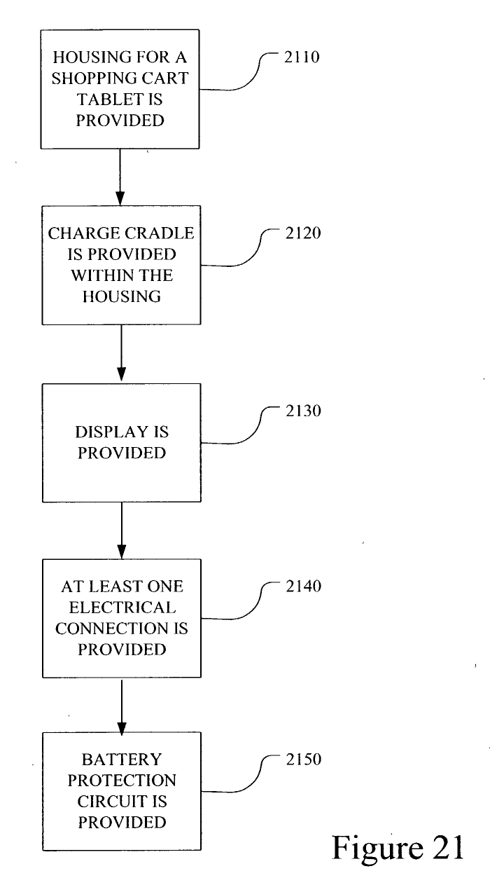

While, for purposes of simplicity of explanation, the methodologies of FIGS. 21-27 are shown and described herein as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

Turning now to FIG. 21, a methodology for fabricating a shopping cart tablet is depicted. The methodology begins at 2110 where a housing for the shopping cart tablet is provided. The housing can be fabricated from a metal, high strength plastic, and/or any other suitable material. At 2120, the housing is provided with a charge cradle to support a portable electronic terminal, such as a barcode reader. At 2130, the housing is provided with a display for displaying product information scanned by the portable electronic terminal. The housing is also provided with at least one electrical connection at 2140 to connect to a docking station or other charging device. At 2150, a battery protection circuit is provided in the housing. The battery protection circuit is operable to mitigate damage from excess charging, voltage, and/or temperature.

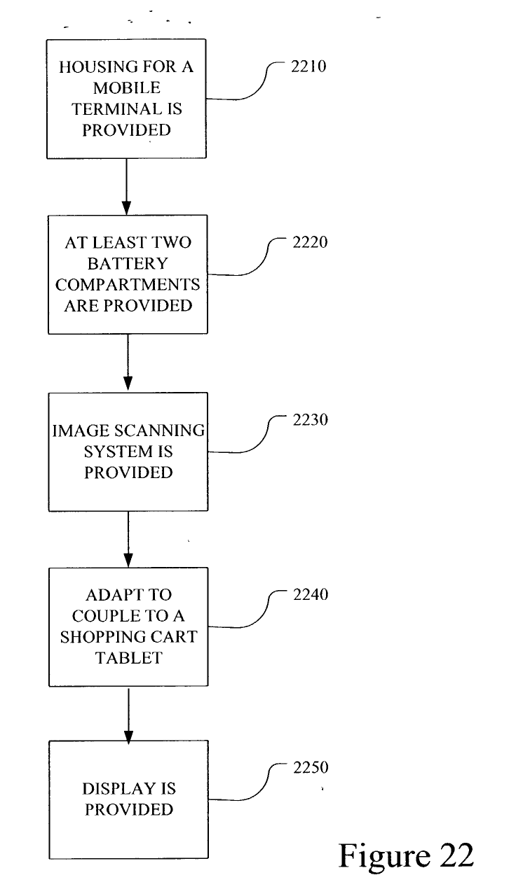

FIG. 22 illustrates a methodology for fabricating a mobile terminal in accordance with an aspect of the present invention. The methodology begins at 2210 where a housing for the mobile terminal is provided. The housing can be fabricated from a metal, high strength plastic, and/or any other suitable material. At 2220, the body of the housing is adapted to receive at least one to distribute the size and weight of the battery(s) over the mobile terminal housing, rather then employing a conventional battery compartment. At 2230, an image scanning system is provided within the housing of the mobile terminal. The image scanning system is operable to scan and decode a bar code of a product, for example. The mobile terminal is further adapted to couple to a shopping cart tablet, at 2240. For example, the mobile terminal can include at least one electrical connection for electrically connecting to a charge cradle of the shopping cart tablet. Additionally, the mobile terminal can be equipped for wireless communication with the shopping cart tablet. At 2250, a display is provided to display product information of a scanned product and/or an operational status of the mobile terminal.

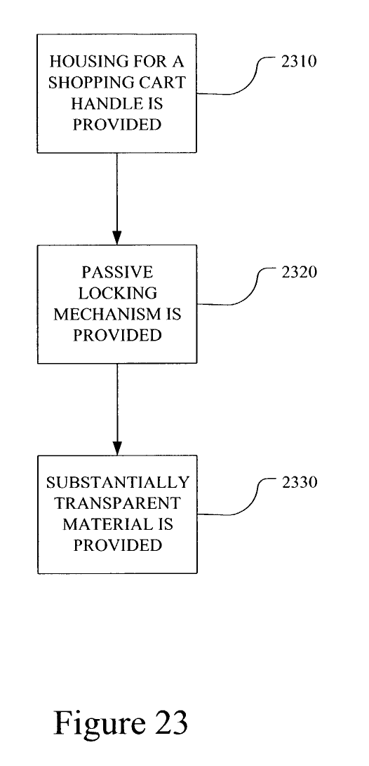

FIG. 23 illustrates a methodology for fabricating a shopping cart handle in accordance with an aspect of the present invention. The methodology begins at 2310 where a housing is provided. The housing includes a gripping portion which is angled such that a user's wrist is positioned in a neutral position when gripping the shopping cart handle. At 2320, a passive locking mechanism is provided on the shopping cart handle for coupling of the handle with a shopping cart tablet and/or mobile terminal. The passive locking mechanism comprises a recess which corresponds with an aperture located in the shopping cart tablet and/or mobile terminal. A substantially transparent material is provided on the shopping cart tablet at 2330 for allowing the application of logos and/or legends on the shopping cart handle. The shopping cart handle further includes a mounting mechanism for coupling the shopping cart handle to at least one frame portion of a shopping cart. The mounting mechanism includes at least one flange portion and at least one mating endcap portion.

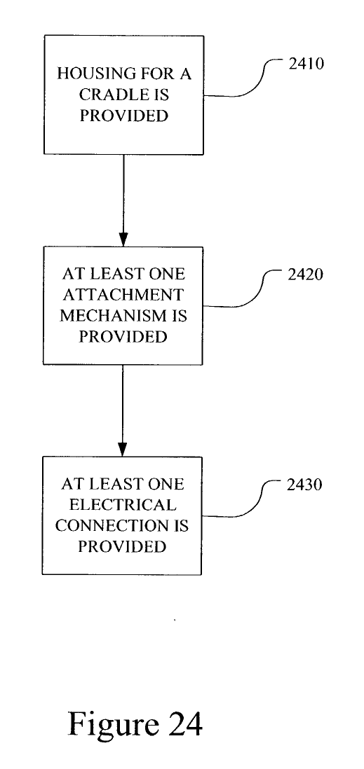

FIG. 24 depicts a methodology for fabricating a modular charge cradle in accordance with an aspect of the present invention. The methodology begins at 2410 where a housing adapted to house a shopping cart tablet and/or a mobile terminal is provided. At least one attachment mechanism is coupled to the housing to facilitate physical connection of a plurality of cradles at 2420. At least one electrical connection is coupled to the housing of the charge cradle at 2430. At least one electrical connection is adapted to facilitate charging of the shopping cart tablet and/or mobile terminal that is docked in the cradle. Another electrical connected can be adapted to facilitate communications between a storage/charging rack and the shopping cart tablet and/or mobile terminal. Accordingly identification information can be passed electronically from the cradle to the shopping cart tablet and/or mobile terminal.

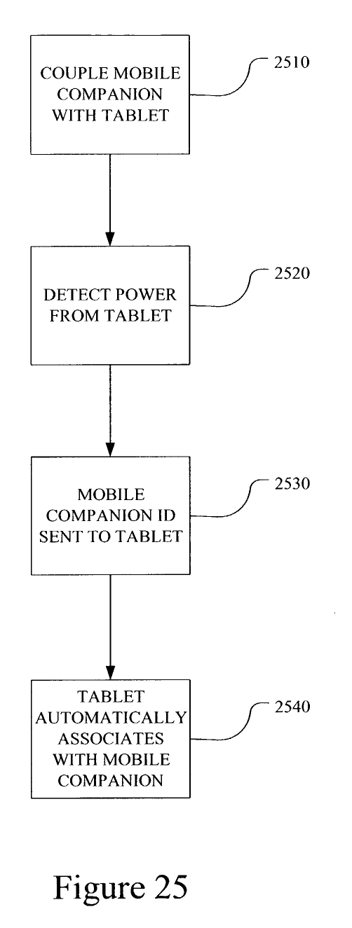

Turning now to FIG. 25, a methodology for providing an auto association between a tablet and a mobile terminal is illustrated. The methodology begins at 2510 where the mobile terminal is coupled with a shopping cart tablet. The mobile terminal can be inserted into a cradle located in the tablet. At 2520, the mobile terminal detects power from the tablet. Then, at 2530, the mobile terminal serially sends an ID associated with the mobile terminal to the tablet. The mobile terminal's ID information is employed by the tablet to automatically associate itself with the mobile terminal. The association can be exclusive to that particular mobile terminal. The auto association facilitates dynamic reconfiguration of the tablet with other mobile terminals; and mitigates the need for manually setting an association between the tablet and the mobile terminal(s).

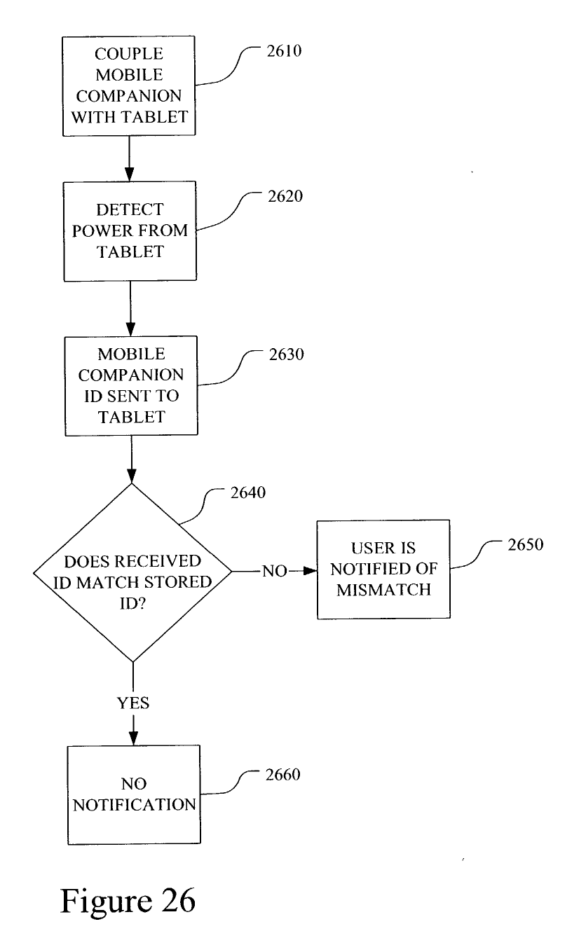

Turning now to FIG. 26, a methodology for incorrect docking notification is depicted. The methodology begins at 2610 where a mobile terminal is coupled with a shopping cart tablet. The mobile terminal can be inserted into a cradle located in the tablet. At 2620, the mobile terminal detects power from the tablet. Then, at 2630, the mobile terminal serially sends an ID associated with the mobile terminal to the tablet. The tablet can determine whether the tablet is properly associated with an assigned mobile terminal. At 2640, the tablet determines if the serial ID stored in the tablet, which was obtained during an initial association, matches the serial ID sent by the mobile terminal. If the stored tablet ID does not match the received ID from the mobile terminal (NO), the user is alerted of the mismatch at 2650. If the stored tablet ID does match the received mobile terminal ID (YES), no notification is provided to the user (2660).

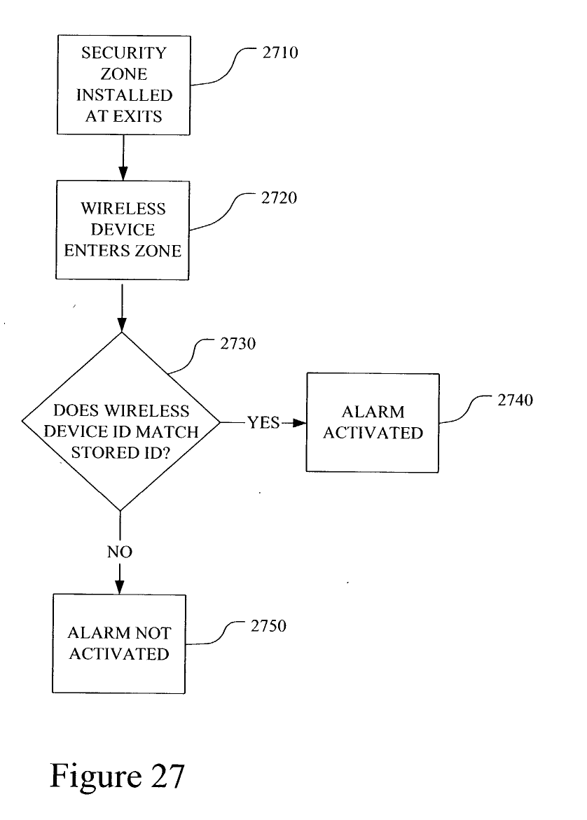

FIG. 27 illustrates a methodology for preventing theft of electronic shopping system components in accordance with an aspect of the present invention. The methodology begins at 2710 where a security zone is installed around at least one exit located in a retail environment. Accordingly, when a device (e.g., shopping cart tablet, mobile terminal) enters the security zone at 2720, identification information about the device is transmitted to the security system. The identification information is compared to a database or listed of known IDs. At 2730, it is determined whether the identification information transmitted to the security system matches a stored ID. If there is a match, the alarm is activated at 2740 to notify personnel at the retail environment that a store device is about to leave the retail environment. However, if no match is found, no alarm is sent (2750), as there may be a plurality of electronic devices not owned by the store that pass through the security zone.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A shopping cart tablet comprising:
a housing for the shopping cart tablet; and
a charge cradle located within the housing to house and charge a portable electronic device.

2. The shopping cart tablet of claim 1, wherein the housing includes a lunchbox style handle.

3. The shopping cart tablet of claim 1, further comprising a display to display product information.

4. The shopping cart tablet of claim 3, wherein the display is a touch screen display.

5. The shopping cart tablet of claim 1, wherein the shopping cart tablet can connect to a least one of a printer, a signature pad, an additional barcode scanner, and a magnetic stripe reader.

6. The shopping cart tablet of claim 1, further comprising an antenna for wireless communication with an access point.

7. The shopping cart tablet of claim 1, further comprising a battery protection circuit to protect a battery from at least one of high charge current, high voltage, and high temperature.

8. The shopping cart tablet of claim 1, further comprising a charging intelligence scheme.

9. The shopping cart tablet of claim 8, wherein battery charge states of the tablet and the second portable electronic device are correlated such that both the battery in the tablet and the battery in the mobile terminal have substantially the same amount of usable life left at any given time.

10. A mobile terminal comprising:
a housing for the mobile terminal;
at least one electrical connection for connecting to a shopping cart tablet.

11. The mobile terminal of claim 10, further comprising a display to display product information.

12. The mobile terminal of claim 11, wherein the display is a touch screen.

13. The mobile terminal of claim 10, further comprising a battery protection circuit to protect a battery from at least one of high charge current, high voltage, and high temperature.

14. The mobile terminal of claim 10, further comprising a plurality of user input keys for accepting or rejected a scanned image.

15. The mobile terminal of claim 10, further comprising a barcode scanner.

16. The mobile terminal of claim 10, further comprising a charging intelligence scheme.

17. The mobile terminal of claim 16, wherein battery charge states of the mobile terminal and the shopping cart tablet are correlated.

18. The mobile terminal of claim 10, further comprising an indicator light to indicate an operational mode of the mobile terminal.

19. The mobile terminal of claim 10, wherein the mobile terminal can connect to a least one of a printer, a signature pad, an additional barcode scanner, and a magnetic stripe reader.

20. A shopping cart handle comprising:
a housing for the shopping cart handle; and
an attachment mechanism coupled to the housing to attach the shopping cart handle to a shopping cart.

21. The shopping cart handle of claim 20, further comprising a passive locking mechanism for coupling a shopping cart tablet to the shopping cart handle.

22. The shopping cart handle of claim 20, further comprising at least one label area for displaying at least one of a logo and product information.

23. The shopping cart handle of claim 20, further comprising an angled gripping portion.

24. The shopping cart handle of claim 20, further comprising a tongue portion for supporting a shopping cart tablet and an angle.

25. The shopping cart handle of claim 20, wherein the attachment mechanism comprises at least one endcap, the endcap corresponding with at least one flange located on the shopping cart handle.

26. The shopping cart handle of claim 25, wherein the attachment mechanism further comprises an endcap cover.

27. The shopping cart handle of claim 25, wherein the endcap comprises an antitorque wedge.

28. A cup holder for a shopping cart comprising:
a receptacle portion; and
a mounting portion, wherein the mounting portion includes at least one spring features for coupling to a frame of the shopping cart.

29. The cup holder of claim 28 being made of a wire.

30. A modular charge cradle comprising:
a housing adapted to support at least one of a shopping cart tablet and a mobile terminal;
at least one electrical connection to connect to at least one of the shopping cart tablet and the mobile terminal; and
a plurality of connector elements for connecting the cradle to at least one other cradle, wherein the connector elements are located at side, top, bottom, and back portions of the housing.

31. The modular charge cradle of claim 30, wherein the at least one electrical connection is employed to charge at least one of the shopping cart tablet and the mobile terminal.

32. The modular charge cradle of claim 30, wherein the cradle can communicate with the at least one other cradle.

33. The modular charge cradle of claim 30, wherein the cradle can recognize identification information from at least one of the shopping cart tablet and the mobile terminal.

34. An electronic shopping system comprising:
a shopping cart tablet; and
a mobile terminal, wherein the shopping cart tablet includes a charge cradle for charging the mobile terminal.

35. The electronic shopping system of claim 34, wherein the shopping cart tablet includes a protrusion for passive locking with a shopping cart handle.

36. The electronic shopping system of claim 34, further comprising a security system to prevent theft of the shopping cart tablet and the mobile terminal.

37. The electronic shopping system of claim 34, wherein the mobile terminal includes an imaging assembly for imaging a barcode.

38. The electronic shopping system of claim 37, wherein the mobile terminal can image the barcode while docked within the charging cradle of the shopping cart tablet.

39. The electronic shopping system of claim 37, wherein the mobile terminal can image the barcode in a hand held mode of operation.

40. The electronic shopping system of claim 34, wherein the shopping cart tablet and the mobile terminal can wirelessly communicate identification information to each other.

41. The electronic shopping system of claim 34, wherein at least one of the shopping cart tablet and the mobile terminal includes a notification component to notify a user if the shopping cart tablet and the mobile terminal are not associated.

42. The electronic shopping system of claim 34, wherein at least one of the shopping cart tablet and the mobile terminal includes an auto association component to automatically associate the shopping cart tablet and the mobile terminal.

43. The electronic shopping system of claim 34, wherein the system can determine the location of at least one of the shopping cart tablet and the mobile terminal within a retail environment.

44. A methodology for fabricating a shopping cart tablet comprising:
providing a housing for the shopping cart tablet; and
providing a charge cradle within the housing to house and charge a mobile terminal.

45. The methodology of claim 44, further comprising providing a display to display product information scanned by a mobile terminal.

46. The methodology of claim 44, further comprising providing at least one electrical connection in the shopping cart tablet to connect to a docking station.

47. The methodology of claim 44, further comprising providing a battery protection circuit in the shopping cart tablet to mitigate damage to a battery from at least one of excess charging, excess voltage, and excess heat.

48. A methodology for fabricating a mobile terminal comprising:
providing a housing for the mobile terminal; and
providing at least one electrical connection to connect the mobile terminal to a shopping cart tablet.

49. The methodology of claim 48, further comprising providing an image scanning system within the housing.

50. The methodology of claim 48, further comprising providing a display to display product information scanned by the mobile terminal.

51. A methodology for fabricating a shopping cart handle comprising:
providing a housing for the shopping cart handle; and
coupling an attachment mechanism to the shopping cart handle to attach the handle to a shopping cart.

52. The methodology of claim 51, wherein the housing includes an angled gripping portion and a center portion.

53. The methodology of claim 51, further comprising providing a passive locking mechanism for coupling the shopping cart handle to a shopping cart tablet.

54. The methodology of claim 51, further comprising providing at least one substantially transparent label area on the housing.

55. A methodology for fabricating a cup holder comprising:
providing a receptacle portion; and
providing a mounting portion for coupling the cup holder to a frame of a shopping cart.

56. A methodology for fabricating a modular charge cradle comprising:
providing a housing for the cradle;
providing a plurality of connector elements to the cradle, wherein the connector elements are located at side, top, bottom, and back portions of the housing.

57. The methodology of claim 56, further comprising providing at least one electrical connection to connect the cradle to at least one of a shopping cart tablet and a mobile terminal.

58. An electronic shopping system comprising:
mobile terminal means for scanning a barcode of a product; and
tablet means coupled to the mobile terminal means.

59. The electronic shopping system of claim 58, further comprising means for mitigating theft of the mobile terminal means and the tablet means.

60. The electronic shopping system of claim 58, further comprising means for supporting the mobile terminal means and tablet means on a shopping cart.

61. The electronic shopping system of claim 58, further comprising means for charging the mobile terminal means and tablet means.

62. A shopping cart tablet comprising:
a housing for the shopping cart tablet;
a charge cradle located within the housing to house and charge a portable electronic device; and
an inference engine located within at least one of the tablet or device, the inference engine performing at least one of a probabilistic-based and statistical-based analysis as to determining a confidence level associated with initiating a desired action.
